(19) United States
(12) Patent Application Publication
(10) Pub. No.: US 2010/0199164 A1
(43) Pub. Date: Aug. 5, 2010

(54) CONTROLLING EDITING OF A PORTION OF A DOCUMENT

(76) Inventors: John William Lumley, Bristol (GB); Roger Brian Gimson, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/362,623

(22) Filed: Jan. 30, 2009

(51) Int. Cl. G06F 17/21; G06F 17/00

(52) U.S. Cl. 715/230; 715/273

(57) ABSTRACT

To control editing of a document, a representation of the document that contains a property indicating an editing scope of a portion of the document is received by a first editor. The first editor modifies the property to change the editing scope of the portion of the document, such that a second editor is allowed to change the portion of the document according to the changed editing scope rather than the editing scope prior to changing of the property.

### CROSS REFERENCE TO RELATED APPLICATION

This application is related to U.S. Ser. No. 11/927,199, entitled “Method of Constructing a Remotely Editable Machine-Readable Document,” filed Oct. 29, 2007, U.S. Patent Publication No. 2008/0104082, which is hereby incorporated by reference.

### BACKGROUND

Variable content documents or variable data documents are documents that contain both static data and variable data. The variable data refers to content that is dynamically bound to the document to produce a result document. By changing the variable data, different result documents are produced, where the result documents can be consumed in any number of ways (e.g., viewed, printed, etc.) by a user.

Traditionally, document editing has been performed by using dedicated standalone editing tools. However, as enterprises (e.g., companies or other organizations) have become more distributed and/or specialized, document editing may be performed by different human editors having varying roles. For example, a particular document can be edited by personnel in different departments of an enterprise. As another example, different parts of a document can be edited by personnel in different companies.

A variable content document can thus be subjected to a relatively complex workflow in which multiple persons are involved in editing different parts of the document. For example, one person may develop the corporate branding elements of the document, a second person may develop a static background of the document that is to be presented to consumers, and a third person may create specific information that can vary for different consumers or different campaigns to be provided in result documents that are produced.

In a complex workflow, it is desirable to afford editors involved in the workflow as much flexibility as possible.

### BRIEF DESCRIPTION OF THE DRAWINGS

Some embodiments of the invention are described with respect to the following figures:

FIG. 1 is a schematic diagram illustrating the processing of documents that incorporate properties indicating elements of the result documents that are editable, where an editing subsystem is provided to allow one or more editors to modify the editing scope of the editable elements in the document, in accordance with an embodiment;

FIG. 2 illustrates an exemplary flow in which multiple human editors have made edits to the editing scope of the editable elements in a document, in accordance with an embodiment;

FIG. 3 is a flow diagram of a process of editing an editing scope of the editable elements in a document, according to an embodiment; and

FIG. 4 is a block diagram of a system in which an embodiment of the invention can be incorporated.

### DETAILED DESCRIPTION

In accordance with some embodiments, a technique or mechanism is provided to control editing of a document that contains at least one editability property indicating an editing scope of a portion of the document. The “editing scope” of a document portion defines one or more of the following: what editing can be applied to the document portion, the manner in which editing can be applied to the document portion, the person or group of persons authorized to edit the document portion, and so forth. A “portion” of a document refers to any subset of the document or the entirety of the document. A subset of the document includes any element of the document, such as text, images, pages, flows, and other elements. In an alternative implementation, the technique or mechanism according to some embodiments can be applied to a document that initially has no (zero) editability properties (under the assumption in such implementation that, initially, editing is permitted unless explicitly forbidden).

The document containing the editability property is received by a first editor, and the first editor is able to modify the editability property to change the editing scope of the portion of the document, such that a second editor is allowed to change the first portion of the document according to the changed editing scope rather than the original editing scope prior to changing of the editability property.

In this manner, one editor can control the editing scope of another editor, such that one editor can control the edits that are performed by other (downstream) editors of a document. A benefit provided by the technique or mechanism according to some embodiments is that greater flexibility is achieved in editing a document in a workflow that can include multiple editors. In a complex workflow, editing capabilities (or powers) of different editors can be tuned in a relatively convenient manner according to different editing roles and positions of editors within the workflow.

In some embodiments, a document that contains the editability property that defines the editing scope of a portion of the document can be a variable content document. A variable content document includes static data and variable data, where the variable data is dynamically bound (or convolved with) to the document. By varying the variable data, different result documents can be produced for consumption by a user, such as for viewing, printing, and so forth.

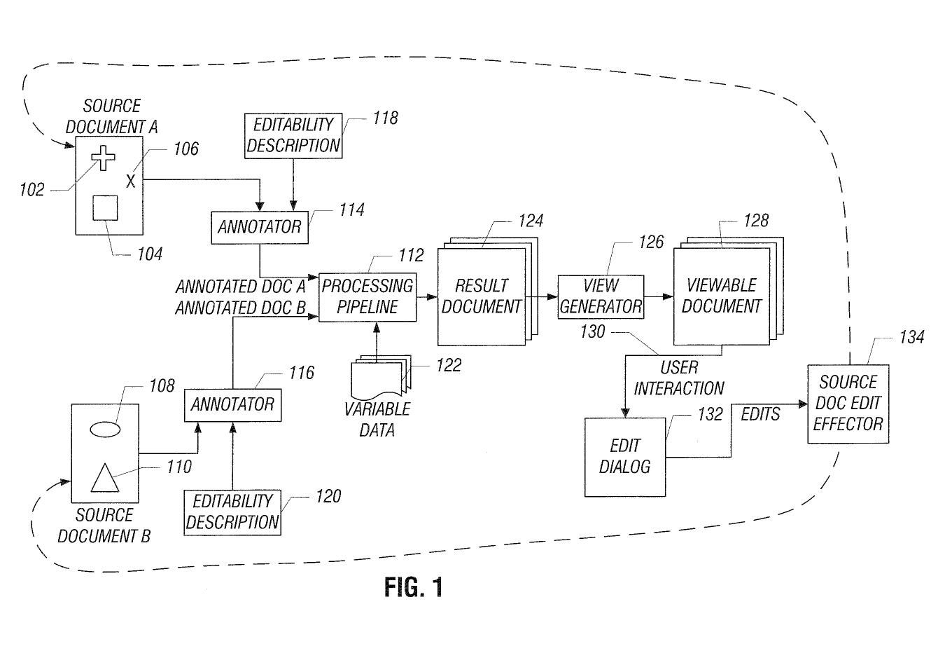

FIG. 1 illustrates an exemplary arrangement of components according to an embodiment. In FIG. 1, it is assumed that two source documents (source document A and source document B) are provided. The source documents can be templates, for example. Variable data can be bound to the source documents to produce result documents.

Multiple source documents are depicted in FIG. 1 to illustrate the modular document architecture that can be employed in some embodiments. A modular document architecture allows multiple document modules (such as source documents A and B) to be merged and bound with variable data to produce a result document. In a different example, just a single source document or more than two source documents can be provided.

In the example of FIG. 1, source document A contains various elements, including a cross 102, a square 104, and an X 106. Source document B contains an oval 108 and a triangle 110. In other examples, source documents A and B can include other or alternative elements, such as text, images, and so forth. Each source document A and source document B can be an Extensible Markup Language (XML) document that contains both program and symbolic output elements that are convolved with an instance of the variable data to produce a result document. In alternative embodiments, source documents A and B can be according to other formats.

Prior to processing, source documents A and B are annotated with edit-processing annotations to indicate which elements of the source documents are editable at this time and by this user, and the editability scope of each such element. To add the edit-processing annotations, source document A is provided to an annotator program 114, and source document B is provided to an annotator program 116. The annotator programs 114 and 116 are used to add the edit-processing annotations to source documents A and B.

The annotator programs 114 and 116 insert the edit-processing annotations based on respective editability descriptions 118 and 120. The edit-processing annotations added to respective annotated documents A and B are temporary information written into the documents during processing to allow corresponding editing actions to be applied to respective elements of the documents.

In one implementation, each annotator program 114 or 116 is compiled from the respective editability description 118 or 120. In another implementation, each annotator program 114 or 116 interprets the respective editability description 118 or 120. The editability descriptions 118 and 120 can also be XML documents (or other types of documents).

In one example, the editability description 118 can specify that the cross 102 in source document A is to be edited, the types of edits that can be applied to the cross 102, the properties of the cross 102 that can be edited (e.g., color, size, etc.), how the edits can be performed, persons (or group of persons) permitted to perform the edits, and other editing parameters. In one example, the editability description 118 does not specify that the square 104 or X 106 of source document A can be edited, which means that these elements of source document A cannot be edited by users.

Similarly, the editability description 120 can specify, in one example, that the oval 108 of source document B can be edited, the types of edits that can be applied to the oval 108, how the edits can be performed, persons (or group of persons) permitted to perform the edits, and other editing parameters.

The annotator program 114 produces an annotated document A containing an edit-processing annotation for the cross 102, while the annotator program 116 produces an annotated document B that has an edit-processing annotation for the oval 108. The edit-processing annotations added are based on the editability descriptions and on the editability properties contained in the source documents.

The annotated documents A and B are provided to a processing pipeline 112, which includes one or more processing components to apply processing on the annotated documents A and B. Another input to the processing pipeline is variable data 122. In the example of FIG. 1, several different instances of the variable data 122 are input to the processing pipeline 112. The processing pipeline merges source document A and source document B, and binds each instance of the variable data 122 to the merged document. The output of the processing pipeline 112 provides result documents 124, where each result document corresponds to a respective instance of the variable data 122. The different instances of the variable data 122 thus produce corresponding different result documents 124.

The result documents 124 can be viewable, or alternatively, the result documents 124 can be provided to a view generator 126 that produces viewable documents 128. When a viewable document 128 is displayed to a user, the user can perform an interactive input in the viewable document 128 to indicate that editing of one or more elements of the viewable document 128 is desirable. In response to such interactive input, an edit dialog 132 invoked to allow properties of the viewable document to be edited. The properties that can be edited are according to the edit-processing annotations that are provided in the annotated documents A and B.

In accordance with some embodiments, the user can also edit the editability properties themselves using the edit dialog 132. For example, the user can specify that a downstream user must have a certain access (security) level before the downstream user can make edits to certain elements of the document.

Note that the editability properties in the document are examined by the annotator programs 114 and 116 (or another program) to determine whether specific edits can be made. Moreover, further predicate testing can be performed by the annotator programs. The predicate testing defines further one or more criteria or constraints for each respective element of the document that would have to be satisfied to allow edits to be made.

In response to edits made by a user (including edits made to editability properties) in the document, the edits are propagated back to the source documents A and B by a source document edit effector 134. As a result, the editability properties in source documents A and B are modified by the source document edit effector 134 based on the edits made by the user in the edit dialog 132. The edits that are propagated back to the source documents A and B are then re-processed by the processing pipeline 112 and view generator 126 to produce an updated result document that contains the edits.

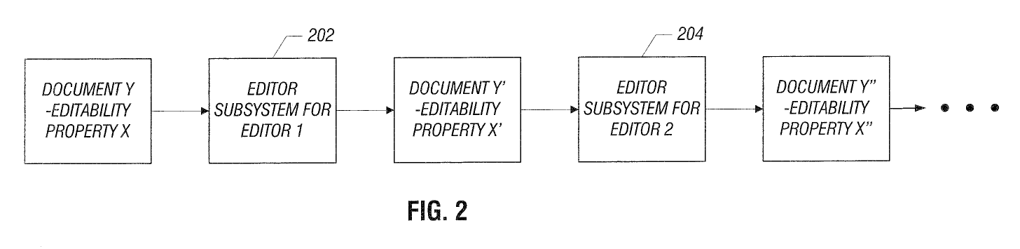

FIG. 2 illustrates an example flow of a document Y that is edited by two human editors: editor 1 and editor 2. Document Y has an editability property X that specifies the current editing scope for a portion of document Y.

Document Y with its editability property X is received by an editor subsystem 202 that is used by editor 1. The editor subsystem 202 includes the annotator programs 118, 120, view generator 126, edit dialog 132, and source document edit effector 134 shown in FIG. 1, as well as other modules for receiving user inputs for editing document Y. Editor 1 can perform allowed edits on document Y according to the editability property X. The editability property X can specify that the editability property X itself can be modified.

To control the editing scope of a downstream editor (editor 2), editor 1 modifies the editability property X in document Y. Editor 1 can use the edit dialog 132 of the editor subsystem 202 to make the desired change to the editability property X. Any change to the editability property X is effected in document Y by the source document edit effector 134. As a result of the changes made by editor 1 using the editor subsystem 202, a document Y′ is produced that has editability property X′, where editability property X′ is different from editability property X in document Y.

Next, document Y′ is provided to an editor subsystem 204 that is accessed by editor 2. Editor 2 can then effect allowed edits on a portion of document Y′, according to the editing scope defined by editability property X′. The edits made by editor 2 are effected by the source document edit effector 134 of the editor subsystem 204, and document Y″ is created. Assuming that editor 2 has made edits to editability property X′ to further change the editing scope allowed for further downstream editors, document Y″ contains editability property X″. The above procedure can be repeated by further editors in the workflow associated with the document.

The following describes edits of exemplary editability properties that can be performed on an exemplary document. The example involves a document having the following hierarchical arrangement of elements, including pages, flows, circle, text, and image.

```
Page 1
  Flow
    Circle
    Text
    Image
Page 2
  Image
  ...
```

The hierarchical document includes two pages (page 1 and page 2), where each page contains respective sub-elements. In this example, a page is the highest level element of the document. In the above example, page 1 includes a flow, which defines the layout or order of further elements in page 1. The other elements in page 1 (according to the defined flow) include a circle, text, and image. Page 2 includes an image and possibly other elements (not shown).

In some implementations, it is assumed that human editors can be associated with various edit or access levels, where a higher level indicates more editing power than a lower level. In other implementations, other types of edit permissions can be specified. For example, the edit permissions can specify that some users have permission to edit colors of elements in a document, while other users do not have permission to edit colors of elements in a document. Other forms of edit permissions can also be specified by editability properties.

In one example, assume that a human editor with level4 permission begins to edit the foregoing document, which is associated with the following exemplary editability description (e.g., 118 or 120 in FIG. 1):

Match=“Page” . . . (change of element and properties allowed)

Match=“Text” . . . (change of element and properties allowed)

Match=“Image” . . . (change of element and properties allowed)

In the above example editability description, edits can be made to a page, text, and image. The editability description for each element (page, text, or image) also specifies the editability scope of edits that can be made to the respective element, such as changing simple properties such as size or adding or deleting child elements. In the above example, indications are also provided in the editability description that changes to the editability of each of the page, text, and image elements of the document are allowed (to allow a user to modify the editing scope of such elements). According to the editability description in the example above, pages, text, and images can be edited, but not circles.

The first human editor with a level4 edit level makes the following edits to the document:

```
Page 1
  Flow
    Circle
    Text editable = “level2”
    Image editable = “level2”
Page 2 editable = “level3”
  Image
  ...
```

The edits made by adding the editability properties indicate that a user at level2 or above is able to, in the future, make edits to text and image elements in page 1, while a user with edit level3 or above can make edits to page 2. Thus, any subsequent editor with less than a level2 edit level would not be able to edit the text and image elements identified above, nor make edits to the page element identified above. The edit level specified by the editability property thus specifies the minimum access level of a user that is allowed to make the edits.

Note that in the above example, no editability property is associated with the image element in page 2. However, since this image element is a child of page 2, the image element could inherit any editability property associated with its closest ancestor, in this case the page 2 element. Thus, based on this inheritance characteristic, the image element in page 2 can be edited by anyone with a level3 edit level. In a different implementation, child elements do not have to inherit editability properties of ancestor elements. More generally, a policy can be specified to declare what elements would inherit editability properties from ancestor elements and what other elements would not inherit editability properties from ancestor elements.

Assuming the next (second) editor has a level3 edit level, this second human editor is allowed to make changes to the annotated identified elements of the document. In this example, it is assumed that the second human editor has deleted the image element from page 1, changed the editability property of the text element in page 1 to indicate that this text element is not editable, added an editability property to the image element of page 2, and added a new text element to page 2 with an associated editability property. The exemplary changes are illustrated below:

```
Page 1
  Flow
    Circle
    Text
Page 2 editable = “level3”
  Image editable = “level1”
  Text editable = “level1”
```

The image element in page 2 is made editable for anyone with a level1 edit level, and the new text element in page 2 is also editable by anyone with a level1 edit level.

Effectively, by including the editability properties in the documents as indicated above, the editability permissions specified by the editability description (e.g., 118 or 120 in FIG. 1) are further constrained. For example, the second human editor in the example above has the following effective editability description:

Match=“Page [closest (@ editable)≦editable level3]”

Match=“Text [closest (@ editable)≦editable level1]”

Match=“Image [closest (@ editable)≦editable level1]”

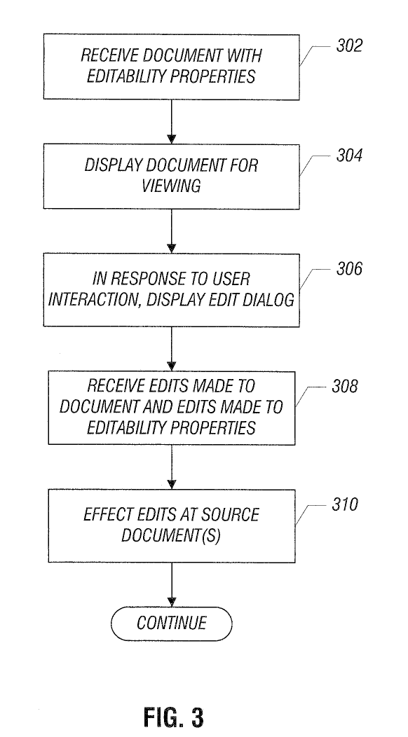

FIG. 3 shows a procedure performed by an editor subsystem (e.g., 202 or 204 in FIG. 2), in accordance with an embodiment. A document with editability properties is received (at 302). The document is then displayed (at 304) for viewing. In response to user interaction, such as by a user clicking on an editable part of the document, an edit dialog is displayed (at 306).

The human editor can make edits using the edit dialog, including edits of portions of the document as well as edits to editability properties. The edits made to the document and edits made to editability properties are received (at 308). The annotator programs (e.g., 118, 120 in FIG. 1) or other programs have already predetermined whether the edits are allowed—if they were not the edit-processing annotations would not have been added during annotation. If allowed, the edits are effected (at 310) by the source document edit effector 134 (FIG. 1) in the source document(s).

This process can be repeated at the next editor subsystem based on interaction with another human editor.

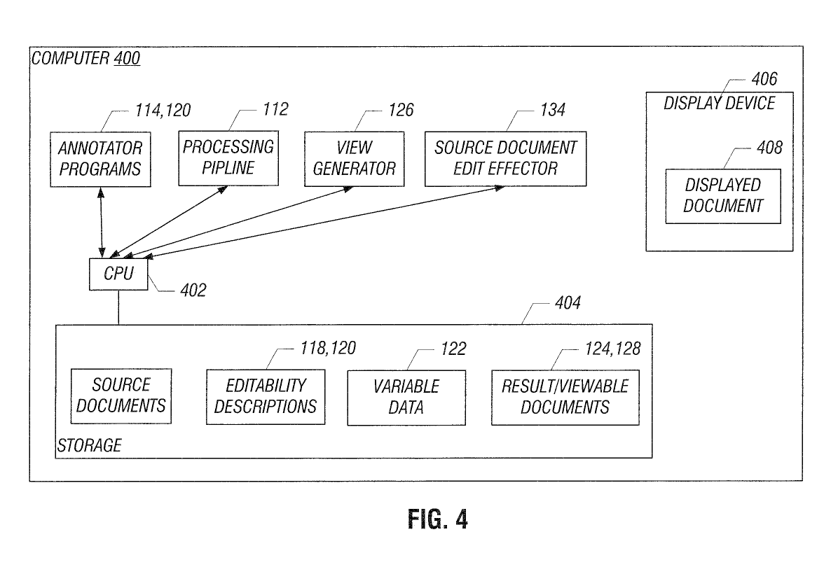

FIG. 4 shows an exemplary arrangement of a computer 400 that can be used to perform tasks described above. The computer 400 includes various software modules, including annotator programs 114, 116, the processing pipeline 112, the view generator 126, and the source document edit effector 134, which are executable on one or more central processing units (CPUs) 402.

The CPU(s) 402 is (are) connected to a storage 404, which contains source documents, editability descriptions 118, 120, variable data 122, and the result/viewable documents 124, 128. Although the various software modules are depicted as being in one box, note that the computer 400 can represent a distributed computing system that has computing nodes located remotely from each other, and connected by one or more networks.

The computer 400 also includes a display device 406 in which a document 408 annotated with edit-processing annotations as described above can be displayed. Based on the displayed document, a human editor can make edits to portions of the displayed document as well as to editability properties in the document provided this is allowed by the edit-processing annotations.

Note that there can be multiple computers 400 for used by distinct human editors. The multiple computers 400 can be connected over a network, such as a local area network (LAN) or the Internet. The human editors that are able to edit a document can be part of the same organization, or alternatively, the human editors can be part of different organizations.

Instructions of software described above (including annotator programs 114, 120, processing pipeline 112, view generator 126, and source document edit effector 134 of FIG. 4) are loaded for execution on a processor (such as one or more CPUs 402 in FIG. 4). The processor includes microprocessors, microcontrollers, processor modules or subsystems (including one or more microprocessors or microcontrollers), or other control or computing devices. As used here, a “processor” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method executed by a computer of controlling editing of a document, comprising:
receiving, by a first editor, a representation of the document that contains a first property indicating an editing scope of a first portion of the document; and
modifying, by the first editor, the first property to change the editing scope of the first portion of the document, such that a second editor is allowed to change the first portion of the document according to the changed editing scope rather than the editing scope prior to changing of the first property.

2. The method of claim 1, wherein receiving the representation of the document comprises receiving the representation that is produced by merging the document with an instance of variable data.

3. The method of claim 2, wherein receiving the representation that is produced by merging the document with an instance of variable data comprises receiving the representation that is produced by merging a template with the instance of variable data, wherein the representation is a result document.

4. The method of claim 1, further comprising:
annotating the document with a first annotation using an annotator, wherein the annotating is based on an editability description that identifies elements of the document that are editable and on the first property.

5. The method of claim 1, wherein the editing scope indicates an edit level specifying a minimum access level of a user that is allowed to make an edit of the first property.

6. The method of claim 1, further comprising:
invoking an edit dialog to allow the editor to modify the first property.

7. The method of claim 6, further comprising:
checking based on the first property whether the editing scope of the portion of the document should be made available for editing.

8. The method of claim 6, further comprising:
propagating, using an edit effector, an edit made using the edit dialog to the document.

9. The method of claim 1, wherein the first property further specifies types of edits that can be made to the portion of the document, and a user or group of users that are allowed to make edits.

10. The method of claim 1, further comprising:
receiving, by the second editor, a second representation of the document that contains the modified first property; and
further modifying, by the second editor, the modified first property to further change the editing scope of the first portion of the document, such that a third editor is allowed to change the first portion of the document according to the further changed editing scope.

11. The method of claim 1, wherein receiving the representation of the document further comprises receiving the representation of the document that further contains a second property indicating an editing scope of a second portion of the document, the method further comprising:
modifying, by the first editor, the second property to change the editing scope of the second portion of the document.

12. The method of claim 1, wherein the document is a hierarchical document having elements at plural hierarchical levels, and wherein the first property is associated with a first element at a first hierarchical level, and wherein a second element that is a child of the first element inherits the editing scope specified by the first property for the first element.

13. A computer comprising:
a processor; and
software executable on the processor to:
present for viewing a result document produced from a source document, wherein the source document has an editability property specifying an editing scope of a portion of the document;
receive user interaction from a first user to edit the editability property; and
effect the edit of the editability property at the source document to modify the editing scope of the portion of the document, wherein the modified editing scope changes an editing capability of a second user.

14. The computer of claim 13, wherein the software is executable to bind variable data to the source document to produce the result document.

15. The computer of claim 13, wherein the source document is a hierarchical document having elements at plural hierarchical levels, and wherein the editability property is associated with a first element at a first hierarchical level, and wherein a second element that is a child of the first element inherits the editing scope specified by the property for the first element

16. An article comprising at least one computer-readable storage medium containing instructions that when executed cause a computer to:
receive, from a first editor, a representation of the document that contains a first property indicating an editing scope of a first portion of the document; and
modifying, in response to a request from the first editor, the first property to change the editing scope of the first portion of the document, such that a second editor is allowed to change the first portion of the document according to the changed editing scope rather than the editing scope prior to changing of the first property.
